(19) United States
(12) Patent Application Publication
(10) Pub. No.: US 2025/0168944 A1
(43) Pub. Date: May 22, 2025

(54) ENHANCED ILLUMINATION OF A LIGHT CIRCUIT HAVING PROGRAMMABLE LEDs

(71) Applicant: LEDup Manufacturing Group Limited, Irwindale, CA (US)

(72) Inventor: Jing Jing Yu, Irwindale, CA (US)

(73) Assignee: LEDup Manufacturing Group Limited, Irwindale, CA (US)

(21) Appl. No.: 18/944,460

(22) Filed: Nov. 12, 2024

Related U.S. Application Data
(60) Provisional application No. 63/548,037, filed on Nov. 10, 2023.

(51) Int. Cl. H05B 45/10; F21S 4/10; F21Y 115/10; H05B 45/20; H05B 45/46; H05B 47/155

(52) U.S. Cl. CPC H05B 45/10; F21S 4/10; H05B 45/20; H05B 45/46; H05B 47/155; F21Y 2115/10

(57) ABSTRACT

Disclosed are circuits for enhancing the illumination of a LED light string using a programmable LED. A white or single color LED can be connected either in parallel or in series to create a LED module which is substantially less expensive than a LED module containing two programmable color LEDs, since white or single color LEDs are substantially less expensive than programmable color LEDs. A resistor can be placed in series with the white or single color LED so that the white or single color LED creates greater illumination than the programmable color LED to thereby enhance the light emitted from the light module.

### BACKGROUND OF THE INVENTION

LED light circuits, such as LED light strings, have provided a convenient way to provide decorative lighting for various applications. For example, LED light strings have provided decorative lighting to outdoor venues of all types, including meeting locations, gathering points, outdoor bars, swimming pools, outdoor restaurants, pathways, etc. In many of these outdoor locations, it is important to provide a sufficient amount of light, as well as decorative features, such as those provided by programmable color LEDs.

### SUMMARY OF THE INVENTION

The present invention may therefore comprise a method of creating enhanced illumination of a light string comprising: providing a programmable color light emitting diode that can be programmed to generate a plurality of colors; connecting the programmable color light emitting diode to an electrical circuit having a direct current voltage; providing a white or single color light emitting diode, that has a luminous output that is greater than the programmable color light emitting diode; connecting the white or single color light emitting diode in the electrical circuit with the programmable color light emitting diode to form a first light module; connecting a resistor in series with the white or single color light emitting diode that controls the current flowing through the white or single color light emitting diode and illumination of the white or single color light emitting diode; selecting the resistor to cause the white or single color light emitting diode to have an illumination level that is greater than an illumination level of the programmable color light emitting diode so that the enhanced illumination of the light string is created.

The present invention may further comprise an enhanced illumination light emitting diode light string comprising: a programmable color light emitting diode that is configured to be programmed to generate a plurality of colors; an electrical circuit that is conductively connected to the programmable color light emitting diode that supplies power and lighting instructions to the programmable color light emitting diode; a white or single color light emitting diode that is connected to the electrical circuit and receives power from the electrical circuits; a resistor connected in series with the white or single color light emitting diode that controls the flow of current through the white or single color light emitting diode, the resistor having a resistive value that causes the white or single color light emitting diode to have an illumination level that is greater than an illumination level of the programmable color light emitting diode.

### BRIEF DESCRIPTION OF THE DRAWINGS

FIG. 1 is a circuit diagram for an enhanced illumination circuit for color LEDs and white LEDs in parallel.

FIG. 2 is a schematic diagram of a circuit for enhanced illumination color LEDs in series with white LEDs.

FIG. 3 is a circuit diagram of enhanced illumination color LEDs in parallel with white LEDs and placed in light banks.

### DETAILED DESCRIPTION OF THE EMBODIMENTS

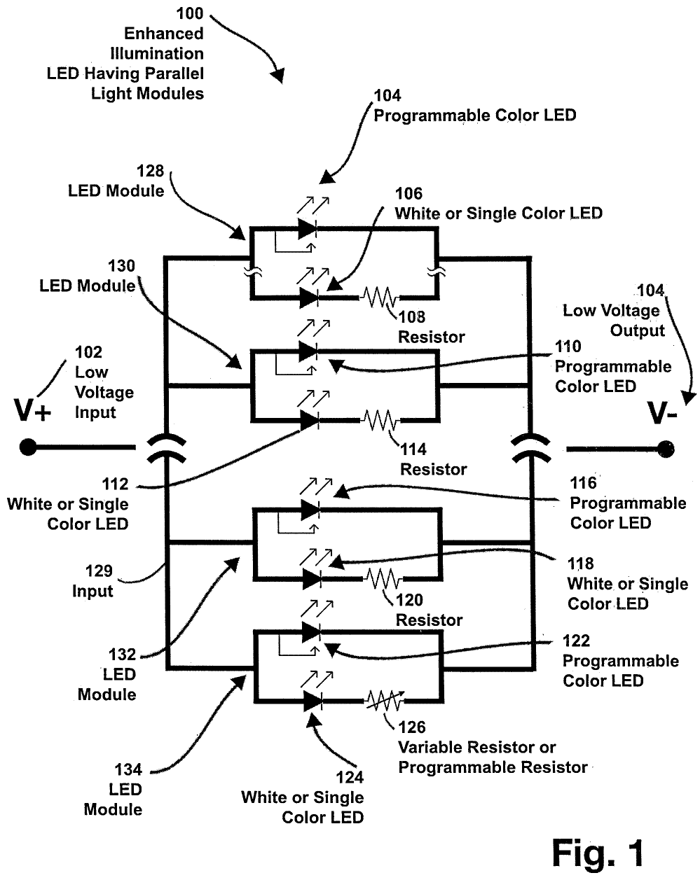

FIG. 1 is a schematic circuit diagram for an enhanced illumination LED light circuit having parallel light modules using both programmable color LEDs and white or single color LEDs. As illustrated in FIG. 1, a plurality of LED modules 128, 130, 132, 134 are connected in parallel between a low voltage input 102 and a low voltage output 104. Each of the LED modules includes a programmable color LED and at least one white or single color LED. For example, LED module 128 includes a programmable color LED 104 and a white or single color LED 106. As shown by the broken lines, more than one white or single color LED can be placed in parallel with the programmable color LED 104. Resistor 108 is connected in series with the white or single color LED 106 to control the illumination output of the white or single color LED 106. Resistor 108 is selected so that the illumination output of the white or single color LED is greater than the light output of the programmable color LED. Similarly, LED module 130 includes a programmable color LED 110 and is connected in parallel with a white or single color LED 112. Series resistor 114 is connected to the white or single color LED 112. The value of the resistor 114 controls the illumination of the white or single color LED 112. Module 132 includes a programmable color LED 116 and a white or single color LED 118 connected in parallel to the programmable color LED 116. Resistor 120 is connected in series with the white or single color LED 118. LED module 134 includes a programmable color LED 122, which is connected in parallel with a white or single color LED 124, which is connected in series with variable resistor or programmable resistor 126. The input 129 is connected to each of the modules 128-134, and output 130 is connected to the output of each of the modules 128-134.

Each of the programmable color LEDs 104, 110, 116, 122 can be programmed to produce different colors at different times. Each of the programmable color LEDs includes a processing chip that controls the color output of the programmable color LED. The programmable color LEDs can be quite expensive because of the processing chip that is included with the programmable color LED.

In some situations, it is beneficial to add additional illumination, such as in dark locations at night, while still retaining the decorative features of being able to display color. Standard white LEDs, such as white LEDs 106, 112, 118, 124 or single color LEDs, are only a fraction of the cost of the programmable color LEDs. White LEDs can be connected in parallel with the programmable color LEDs, as illustrated in FIG. 1, to enhance the overall illumination output of each of the LED modules 128, 130, 132, 134, without detracting from the color output of the programmable LEDs 104, 110, 116, 122. The light output of white LEDs, such as LEDs 106, 112, 118, 124, is controlled by the amount of resistance of resistors 108, 114, 120, 126, respectively. Resistor 126 is a variable resistor or programmable resistor, which can be used to change the amount of illumination of the white LED 124. Variable or programmable resistors can be used in each of the modules 128, 130, 132, 134 to increase or decrease the illumination of white LEDs 108, 112, 118, 124, respectively. A variable or programmable resistor can be provided in each of the modules, if desired, to change the illumination of the white LEDs. In addition, the white LED can be a single color LED to further complement the programmable color LEDs 104, 110, 116, 122. The monochromatic color LEDs that replace the white LEDs 106, 112, 118, 124 can also be made inexpensively at a fraction of the cost of programmable color LEDs. By placing the white LED 106 in parallel with the programmable color LED 104, the white LED 106 can add to the perceived illumination of the programmable color LED 104 so as to provide additional illumination without the added expense of another programmable color LED 104. In some cases, the white LED 106 can be placed in close proximity to the programmable color LED 104, e.g., about 5 mm, to enhance the illumination output of the programmable color LED 104. Enhanced illumination occurs whether or not the white LED is placed in close proximity to the programmable color LED.

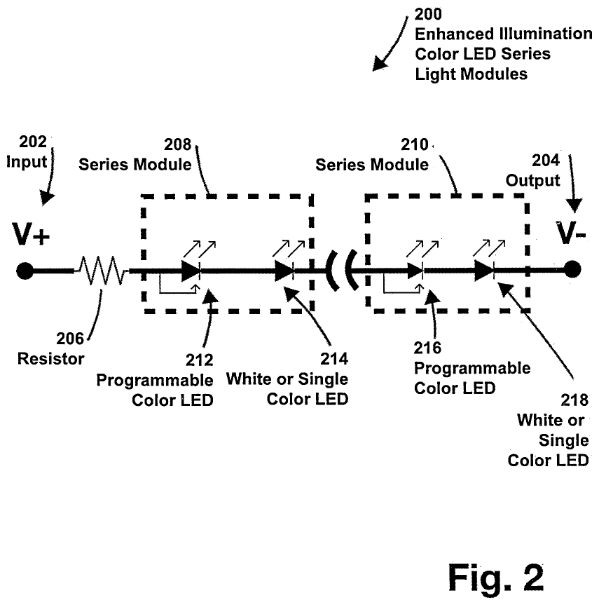

FIG. 2 is a schematic circuit diagram of an enhanced illumination color LED in a series circuit 200. Input 202 is a low voltage input which powers the LEDs in the series circuit 200. Resistance 206 limits the current between the input 202 and the output 204. The programmable color LED 212 generates a color output that can be programmably changed via instructions modulated on the power input of the series circuit 200, illustrated in FIG. 2. Similarly, programmable color LED 216 can be programmed by instructions modulated on the power signal of the series circuit 200 of FIG. 2. White LED 214 is a fraction of the cost of the programmable color LED 212. The white LED 214 enhances the illumination of the series circuit 200 and can also enhance the perceived illumination output of the programmable LED 212. The programmable LED 212 and white LED 214 can be placed in a series module 208 to enhance the illumination of the programmable color LED 212, and the entire series circuit 200 illustrated in FIG. 2. The same is true for the series module 210, which includes a programmable color LED 216 and a white LED 218. Enhanced illumination is created inexpensively as a result of the white LED 218 being priced at a fraction of the cost of adding another programmable color LED 216. Again, the white LEDs 214, 218 do not need to be placed in close proximity with the programmable color LEDs 212, 216, respectively, but can simply be added to the circuit to enhance the overall illumination of the series circuit 200.

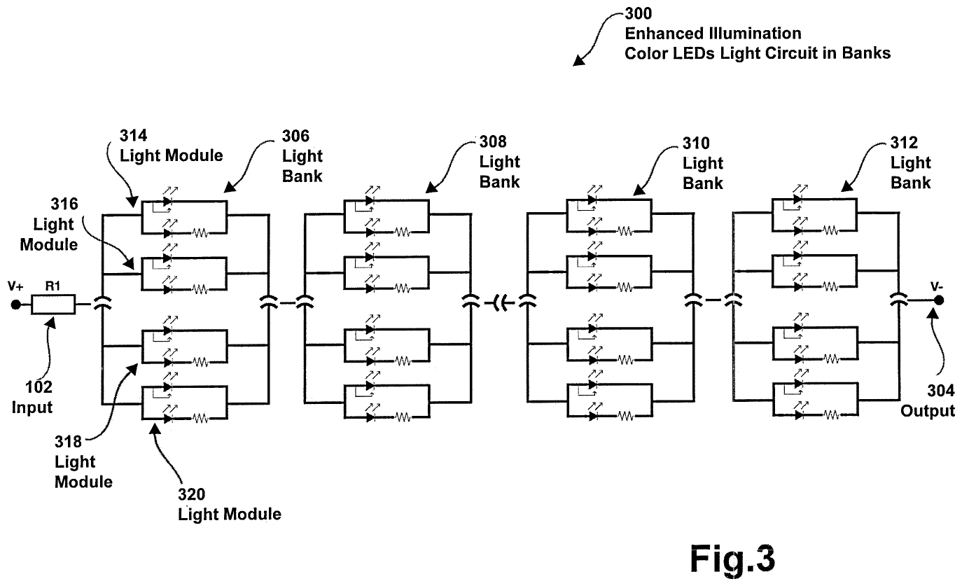

FIG. 3 is a schematic circuit diagram of an enhanced illumination LED light circuit having light modules placed in parallel in light banks. As illustrated in FIG. 3, light bank 306 includes four or more light modules 314,316,318,320. Of course, as few or as many light modules as desired can be placed in light bank 306, depending upon the overall output desired for the light bank 306. As also illustrated in FIG. 3, a series of light banks 306, 308, 310, 312 can be placed in series between the input voltage 302 and the output voltage 304. This also increases the overall illumination of the light string 300.

The present invention therefore provides a circuit that can use white or single color LEDs that are inexpensive and have a high illumination output to increase the illumination of programmable color LEDs. If the white or single color LED is placed in close proximity to the programmable color LEDs, such as by about 5 mm, the illumination effect of the programmable color LED is enhanced so that the programmable color LED appears to have a greater illumination. As such, the overall visual effect is that the programmable color LED has enhanced illumination by inexpensively placing a white LED or another single color LED proximate to the programmable color LED. Further, the resistive value of the resistor in series with the white LED or single color LED can be used to control the illumination output of the white or single color LED by making the illumination of the white or single color LED greater than the programmable color LED. The illumination effect of the module containing the programmable color LED and the white or single color LED is enhanced using a much less expensive white or single color LED, as compared to one or more programmable color LEDs.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of creating enhanced illumination of a light string comprising:
providing a programmable color light emitting diode that can be programmed to generate a plurality of colors;
connecting said programmable color light emitting diode to an electrical circuit having a direct current voltage;
providing a white or single color light emitting diode, that has a luminous output that is greater than said programmable color light emitting diode;
connecting said white or single color light emitting diode in said electrical circuit with said programmable color light emitting diode to form a first light module;
connecting a resistor in series with said white or single color light emitting diode that controls the current flowing through said white or single color light emitting diode and illumination of said white or single color light emitting diode;
selecting said resistor to cause said white or single color light emitting diode to have an illumination level that is greater than an illumination level of said programmable color light emitting diode so that said enhanced illumination of said light string is created.

2. The method of claim 1 further comprising:
connecting additional light modules having a white or single color light emitting diode in parallel with said first module to create a light bank.

3. The method of claim 1 further comprising:
connecting additional light modules having a white or single color light emitting diode in series with said first module.

4. The method of claim 1 wherein said white or single color light emitting diode is connected in parallel with said programmable color light emitting diode.

5. The method of claim 1 wherein said additional light modules, having a white or single color light emitting diode, is connected in series with said first module.

6. The method of claim 2 further comprising:
connecting a plurality of light banks in series to form said light string.

7. An enhanced illumination light emitting diode light string comprising:
a programmable color light emitting diode that is configured to be programmed to generate a plurality of colors;
an electrical circuit that is conductively connected to said programmable color light emitting diode that supplies power and lighting instructions to said programmable color light emitting diode;
a white or single color light emitting diode that is connected to said electrical circuit and receives power from said electrical circuits;
a resistor connected in series with said white or single color light emitting diode that controls the flow of current through said white or single color light emitting diode, said resistor having a resistive value that causes said white or single color light emitting diode to have an illumination level that is greater than an illumination level of said programmable color light emitting diode.

8. The light string of claim 7 wherein said electrical circuit is configured to connect said programmable color light emitting diode to said white or single color light emitting diode in parallel to create a light module.

9. The light string of claim 7 wherein said electrical circuit is configured to connect said programmable color light emitting diode to said white or single color light emitting diode in series to create a light module.

10. The light string of claim 8 wherein said electrical circuit is further configured to connect said light module in parallel with additional light modules.

11. The light string of claim 9 wherein said electrical circuit is further configured to connect said light module in series with additional light modules.
